(19) United States
(12) Patent Application Publication
(10) Pub. No.: US 2013/0001908 A1
(43) Pub. Date: Jan. 3, 2013

(54) CONTAINER

(75) Inventor: Juha Karppinen, Oulu (FI)

(73) Assignee: Ride-In Oy, Oulu (FI)

(21) Appl. No.: 13/635,100

(22) PCT Filed: Mar. 3, 2011
(86) PCT No.: PCT/FI11/50180

§ 371 Date: Sep. 14, 2012

(30) Foreign Application Priority Data
Mar. 16, 2010 (FI) 20105263

(51) Int. Cl. B62B 3/00; B62B 3/16

(52) U.S. Cl. 280/79.2

(57) ABSTRACT

A container is for storage, handling, and transportation of an object. The container comprises i.a. a bottom, a body, and a ramp. The container is made moveable by furnishing it with small wheels and by shaping its bottom so that the container can be pulled/pushed on a soft surface. There are lift-up doors at both ends of the container so that the container is passable. In addition, there can be hatchways on the sides of the container.

The invention relates to a container structure for storage, handling, and transportation of an object. The object is typically a motorcycle.

Valuable open vehicles, such as motorcycles, snowmobiles, and ATVs, naturally need a proper storage space to protect them from bad weather, theft, and vandalism. If a fixed garage is available, there is no problem in this respect. However, those living in an apartment building, for example, do not usually have this opportunity, hence having to keep the vehicle out in the yard or possibly in a parking hall. The latter case provides shelter from the weather but no other protection.

There are numerous known storage arrangements especially for motorcycles. Such are among others closeable hood-like, tent-like, or bag-like structures. Their drawback is mechanical weakness and small space, resulting in that there is no room for a person to work inside the storage. There are also simple containers for this purpose which can also fit in a person and tools.

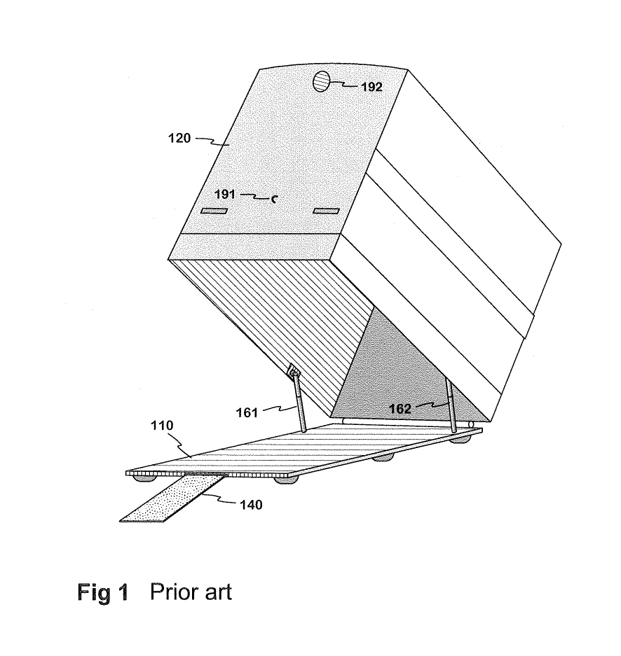

In FIG. 1 there is an example of a relatively roomy, container-like storage known from the website www.hogcabin.com. Its main parts are bottom 110 and body 120 which form an enclosed space in a normal use position. The container is opened by turning the body to an upright position. To this end, the body is hinged to one end of the bottom and the structure includes two hydraulic cylinders 161, 162 to generate the needed thrust. The body turns so much that the motorcycle can be driven in from the opened end. For driving the cycle in and out, a small ramp 140 is hinged to the bottom at the end that is opened. When the container is closed, the ramp can be turned to an upright position against the end wall of the body, whereby the slot in the ramp falls on the loop 191 in the end wall. The container can then be locked with a jack lock.

Brackets (not illustrated in the figure) to which the motorcycle can be tied up securely have been attached to the bottom 110. At the top of the body there is a ventilation vent 192 in order to prevent damage possibly caused by long-term storage. Underneath the bottom there are “paws”, whereby the container can be lifted by for example a forklift and placed to the desired location.

A drawback of the container according to FIG. 1 is that opening it requires a pump that fits the hydraulic cylinder connector. Where the pump is a foot pump, opening the container takes a relatively long time. Further, a person cannot stay in the container for example for service work when the body is closed. Moreover, moving the container is relatively laborious.

An almost identical vehicle storage arrangement has been presented in the application publication US 2004/0232021.

In U.S. Pat. No. 5,593,259 has been disclosed a motor scooter transportation case on wheels that can be reused. The described fixed transportation case is not suitable for use where the scooter needs to be driven in or out repeatedly. The transportation case is suitable for transferring the scooter from one place to another.

U.S. Pat. No. 6,341,451 discloses a portable garage apparatus. In the described garage a car or some other vehicle is driven in or out through an opening at the first end of the garage. The opening can be closed over by lowering down the uplifted door. The opening at the second end of the garage cannot be utilized in driving in or out.

From publication JP 2009078740 is known a self-powered vehicle into which another smaller self-powered means of transport can be driven from both ends of the vehicle. When the smaller means of transport is inside the described vehicle, the latter can be steered from the smaller means of transport. By means of the described arrangement it is possible to speed up the moving of longer distances of for example a person in a wheel chair.

A movable, lightweight storage container solution for lightweight motor vehicles that will still provide a sufficient mechanical protection is not known.

The object of the invention is to diminish said drawbacks related to prior art and to diversify the usage of the container. The container according to the invention is characterized by what is presented in the independent claim 1. Some advantageous embodiments of the invention are disclosed in the other claims.

The basic idea of the invention is the following: The container structure is made movable by furnishing it with small wheels and designing its bottom so that the container can be pulled/pushed on a soft surface. There are doors at both ends of the container which can be turned to an upright position so that the container is passable. In addition, there can be hatchways in the sides of the container.

An advantage of the invention is that an open vehicle, such as a motorcycle, can be driven in the container while the container is on an easy route and the container can then be pushed on its wheels aside to a desired location. A further advantage of the invention is that the vehicle can be driven out of the container in the same direction that it was driven in. A still further advantage of the invention is that a container according to it is suited, in addition to vehicle storage, to transportation of an object off the road. In such a case the wheels of the container have been removed, and it is being pulled. Yet another advantage of the invention is that especially a container with a hatchway is easy to use also as a service site of a vehicle.

In the following the invention is described in detail. In the description, reference is made to the accompanying drawings in which

FIG. 1 shows an example of a prior art container;

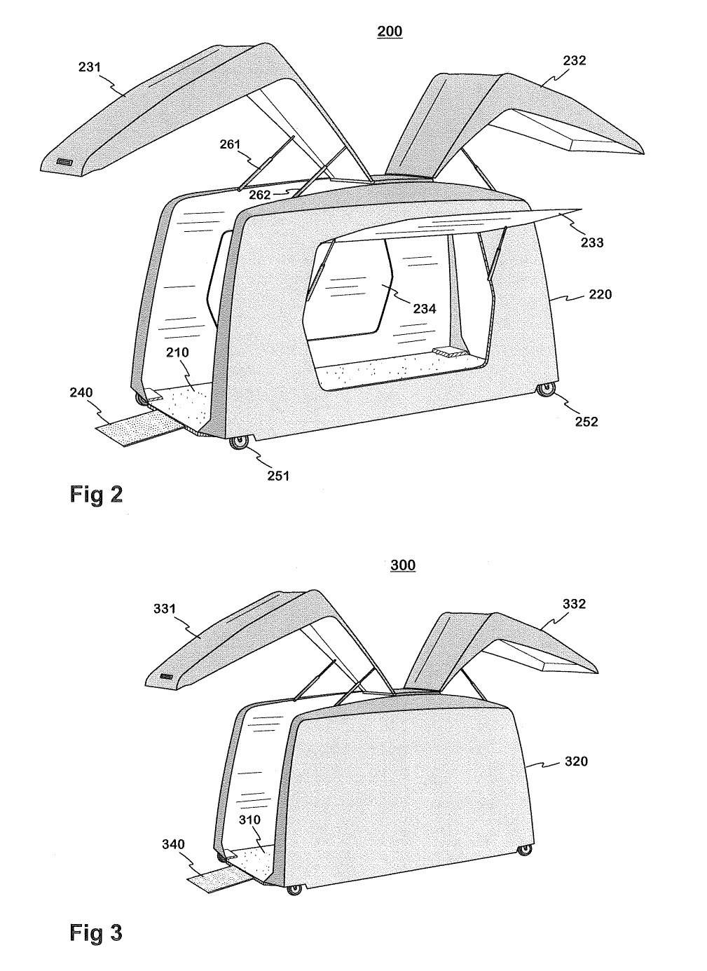

FIG. 2 shows an example of a container according to the invention;

FIG. 3 shows a second example of a container according to the invention;

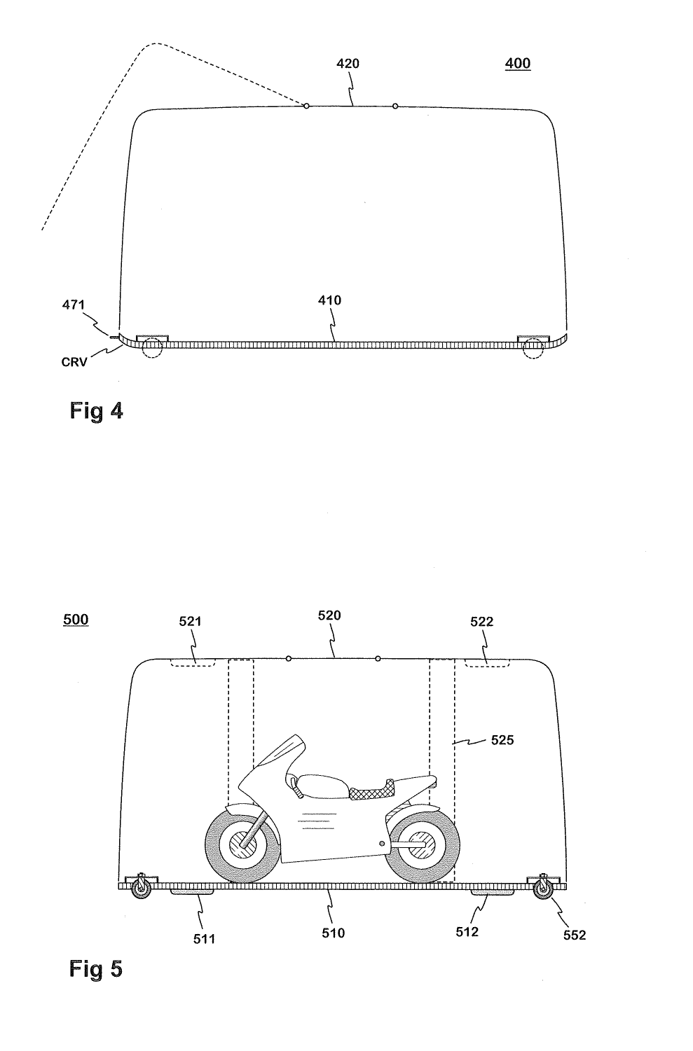

FIG. 4 shows a third example of a container according to the invention;

FIG. 5 shows a fourth example of a container according to the invention; and

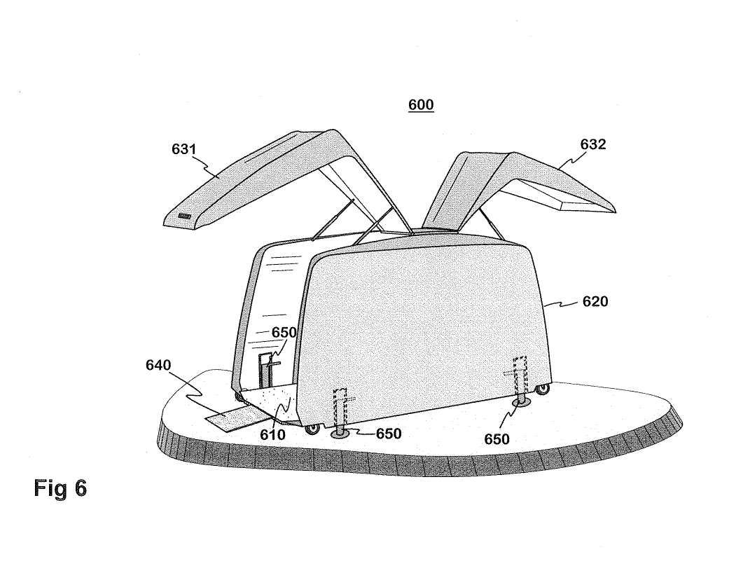

FIG. 6 shows a fifth example of a container according to the invention.

FIG. 1 was explained already in connection with the description of prior art.

In FIG. 2 there is an example of a container according to the invention. The container 200 is intended for storage of an open vehicle such as a motorcycle. Bottom 210 and body 220 form the frame of the container. They are oblong so that the bottom and the entire container have a first and a second end. Correspondingly, the body has a first and a second end, a first and a second side wall, and a roof. The bottom 210 is aluminium, stainless steel, or thick, so-called film plywood, for example. At the first end of the bottom a ramp 240 is attached to its edge by a hinged joint. When the container is closed, the ramp is turned inside the container against the upper surface of the bottom. There can be a corresponding ramp at the second end of the bottom. In each corner of the bottom there is a wheel attached to it, such as the wheels 251, 252 on the first side. The wheels are relatively small, for example 10 cm by diameter, and their fastening mechanism allows them to turn. The container can thus be pushed in different directions without turning the container itself.

The body 220 is for example reinforced plastic, possibly reinforced with aluminium profiles. In this example there are four openings for doors and hatchways in the body when its bottom is imagined to be dosed. The first opening is on the side of the first end of the body, its centre line joins to the longitudinal and vertical direction middle plane, and its width is for example 50 to 70% of the width of the body, being smaller at the top than at the bottom. Here, the first opening starts near the middle point of the roof and extends up until the lower edge of the first end. The second opening is on the other side of the end of the body, its centre line joins to the longitudinal and vertical direction middle plane, and also its width is for example 50 to 70% of the width of the body, being smaller at the top than at the bottom. The second opening starts from the point which is here a little towards the second end from the middle point of the roof and extends up until the lower edge of the second end. The third opening is in the first side wall of the body, about in the middle of it. The height of the third opening is for example 65% of the height of the body and width for example 55% of the length of the body. The fourth opening is in the second side wall of the body opposite the third opening.

There are two doors and two hatchways in the container 200. When closed, the first door 231 covers the first opening, and the second door 232 covers the second opening. The doors are naturally slightly wider than their corresponding openings. Both doors are hinged at their top end to the roof of the body and can be locked from their bottom end to the bottom of the body. The first and second door is lifted up and down manually. In this example they stay in the upright position by force of pressure telescopes 261, 262, In the upright position the free end of both doors is above the roof level of the body. Since both ends of the body can be opened, for example a motorcycle need not be pushed backwards when exiting the container but can be driven straight out.

While closed, the first hatchway 233 covers the third opening and the second hatchway 234 covers the fourth opening. The first hatchway is hinged from its top end to the first side wall of the body and the second hatchway is hinged from its top end to the second side wall of the body. Both hatchways can be locked from their bottom end to the side wall. They are lifted up and down manually and also they stay in the upright position by force of pressure telescopes. In the upright position the free end of both hatchways is higher up than the hinged end. The hatchways in the side walls facilitate servicing the vehicle inside the container and some of the measures carried out on it can be taken care of entirely from the outside through the hatchway opening(s).

The external dimensions of the container 200 are for example 285×130×165 cm³ (length, width, height).

In FIG. 3 there is a second example of a container according to the invention. The container comprises a bottom 310, a body 320, a ramp 340, and a first 331 and second 332 door in the same way as in the example of FIG. 2. The difference with FIG. 2 is that the side walls of the body are now solid; in other words there are no hatchways. The manufacturing costs of the structure are then naturally slightly lower.

In FIG. 4 there is a third example of a container according to the invention. The bottom 400 of the container is designed so that its ends curve slightly upwards. So there are curved portions CRV in the bottom 410. This facilitates moving the container off the road when the ground gives way. In addition, there can be longitudinal grooves/protrusions in the bottom. For the purpose of moving the container there is a drive link 471 at least at its one end. When used off the road, the wheels of the container are detached. When the container 400 is used on a hard surface, the wheels are attached.

A container according to FIG. 4 can be used for example for rescue purposes in which case it is equipped with for example a stretcher, first aid equipment, and heating device.

In FIG. 5 there is a fourth example of a container according to the invention. The container 500 has been implemented so that similar containers can be stacked. To this end there are downward-protruding juts 511, 512 in the bottom 510 and recesses 521 in the roof of the body. Each recess is directly above one bottom jut and slightly larger than this by dimensions. Thus, when a container is lifted atop another, the juts of the top container go into the recesses of the bottom container, thereby securing that the top container cannot fall off. There is the required amount of reinforcements 525 in the body 520 for it to withstand well the weight of a couple of other containers with vehicles inside. The wheels 552 of the container are removed if in the way when stacking the containers.

In FIG. 6 there is a fifth example of a container according to the invention. The container 600 comprises a bottom 610, a body 620, a ramp 640, and a first 631 and second 632 door in the same way as in the example of FIG. 3. The difference with FIG. 3 is that in each corner of the body there are support legs 650 (the covert support leg of the fourth corner is not illustrated in FIG. 6) which can be locked in place. The support legs 650 are locked in the upright position in the transport position of the container 600. In the transport position the legs 650 do not extend down to the ground. When the container 600 is desired to be in a space in which moving it requires a lot of force, the support legs 650 are extended to their lowest position. Then the support legs 650 extend all the way down to the ground and the container stands solely on the support legs 650. Advantageously setting the support legs to standing position can be done when the container 600 is empty. Then the placing-to-position force of the support leg is at its minimum.

Above, a container according to the invention has been described. Its structure may differ in details from what is presented in FIGS. 2-5. For example the number of hatchways can also be one and the mechanism holding them and the doors in the upright position may vary. The shapes of the structural parts, such as doors, may naturally vary. The doors can be for example so-called rolling doors. There can also be an interlocking system in connection with the doors with which the container can be locked from the outside. Also a heating device and an alarm system can be added to a container according to the invention. The invention can thus be implemented in different ways within the scope set by the independent claim 1.

1. A closeable container with a bottom, a body, and a ramp, which body comprises a first and second end, a first and second side wall, and a roof, the container comprising:
a first door hinged in the roof which, when closed, extends down to the bottom part of the first end;
a second door hinged in the roof which, when closed, extends down to the bottom part of the second end;
at least four turning wheels to be mounted to the bottom for transportation on a hard surface; and
a curved portion (CRV) which turns up at least at one end of the bottom for transportation on a soft surface.

2. The container according to claim 1, further comprising a hatchway at least in one of the side walls, which hatchway has been hinged from its top edge to the side wall in question and can be locked from its bottom edge.

3. The container according to claim 1, wherein center lines of said doors join to the longitudinal and vertical middle plain of the body and have a width that is smaller than the width of the body.

4. The container according to claim 1, further comprising downward-protruding juts in the bottom and recesses in the roof of the body, each of which recesses is directly above one jut of the bottom and is slightly larger than the jut by its dimensions, for keeping the stacked containers in place.

5. The container according to claim 1, wherein the body is comprised of plastic.

6. The container according to claim 1, wherein the container comprises support legs in the corners of the body with which the container is configured to be supported to the surface of the storage place.
